(19) United States
(12) Patent Application Publication
(10) Pub. No.: US 2024/0073892 A1
(43) Pub. Date: Feb. 29, 2024

(54) METHOD AND APPARATUS FOR CONFIGURED GRANT BASED TRANSMISSION

(71) Applicant: Telefonaktiebolaget LM Ericsson (publ), Stockholm (SE)

(72) Inventors: Zhipeng LIN, NANJING, Jiangsu (CN); Jingya LI, Göteborg (SE)

(73) Assignee: Telefonaktiebolaget LM Ericsson (publ), Stockholm (SE)

(21) Appl. No.: 18/270,060

(22) PCT Filed: Dec. 20, 2021
(86) PCT No.: PCT/CN2021/139733

§ 371 Date: Jun. 28, 2023

(30) Foreign Application Priority Data
Dec. 31, 2020 (WO) PCT/CN2020/142372

(51) Int. Cl. H04W 72/1268; H04L 1/1812; H04L 5/00; H04W 56/00

(52) U.S. Cl. CPC H04W 72/1268; H04L 1/1812; H04L 5/0051; H04W 56/0015

(57) ABSTRACT

Embodiments of the present disclosure provide methods, apparatus, and computer program products for configured grant (CG)-based transmission. A method comprises: determining one or more synchronization signal and physical broadcast channel blocks (SSBs); determining one or more physical uplink shared channel (PUSCH) resources mapped to the determined one or more SSBs, according to mapping information on mappings between a set of SSBs and a set of PUSCH resources; and transmitting to a network node, data of the CG based transmission by utilizing the determined one or more PUSCH resources.

### TECHNICAL FIELD

The non-limiting and exemplary embodiments of the present disclosure generally relate to the technical field of wireless communications, and specifically to methods, apparatuses and computer programs for configured grant (CG) based transmission.

### BACKGROUND

This section introduces aspects that may facilitate a better understanding of the disclosure. Accordingly, the statements of this section are to be read in this light and are not to be understood as admissions about what is in the prior art or what is not in the prior art.

The 5^{th} generation (5G) communication needs to support services that typically requires only infrequent small data traffic. Examples of these services include traffic from instant messaging (IM) services, such as WhatsApp and WeChat, heart-beat traffic from IM/email clients and other apps, push notifications from various applications, industrial wireless sensors transmitting temperature, or pressure data periodically, etc.

The new radio (NR) supports RRC_INACTIVE state. User Equipments (UEs) with infrequent (periodic and/or non-periodic) data transmission are generally maintained by the network in the RRC_INACTIVE state. Until NR Rel-16, the RRC_INACTIVE state doesn't support data transmission. Hence, the UE has to resume the connection (i.e. move to RRC_CONNECTED state) for any downlink and uplink data. Connection setup and subsequently release to INACTIVE state happens for each data transmission regardless of how small and infrequent the data packets are. This results in unnecessary power consumption and signaling overhead. The signaling overhead for setting up connections before each transmission can be larger than the size of the actual data payload. To reduce the signaling overhead and improve UE battery life, a research on small data transmission (SDT) in RRC_INACTIVE state is ongoing.

Two main solutions are proposed for enabling SDT in RRC_INACTIVE state: RACH-based SDT, which transmits data of SDT on Message A PUSCH (Physical Uplink Shared Channel) in a 2-step RACH (Random Access Channel) procedure, or transmits data of SDT on Message 3 PUSCH in a 4-step RACH procedure; and configured grant (CG) based SDT, which transmits data of SDT over configured grant type-1 PUSCH resources. The 2-step RACH procedure, 4-step RACH procedure and configured grant type-1 PUSCH transmission have already been specified as part of Rel-15 and Rel-16. So, these two solutions enable small data transmission in INACTIVE state for NR.

However, it is not clear how to made association between CG resources and SSBs (synchronization signal and physical broadcast channel blocks) for CG-based SDT.

For RACH-based SDT, a UE can detect one good SSB beam. A random-access preamble in the set of one or more preambles mapped to this good SSB beam can be selected for the random access. Thus, when a gNB detects the selected preamble, the good SSB beam for this UE is known indirectly at the gNB, so that a beam alignment between a UE and a gNB can be achieved. For example, best beams can be used for transmitting signals to or receiving signals from this UE.

For CG-based SDT, the RACH procedure is skipped. After selecting an SSB, a UE will transmit its small data on CG PUSCH resource(s), that is pre-configured for its SDT. Therefore, a gNB cannot know which SSB beam is good for this UE. Consequently, it is hard to improve transmission efficiency for the gNB by using best beams for transmitting signals to or receiving signals from this UE.

Accordingly, it is desirable to achieve beam alignment between a UE and a gNB for CG-based SDT, to improve transmission efficiency.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Various embodiments of the present disclosure mainly aim at providing methods, apparatuses and computer programs for improving transmission efficiency for CG-based transmission by establishing an association between SSBs and resources for the CG transmission. Other features and advantages of embodiments of the present disclosure will also be understood from the following description of specific embodiments when read in conjunction with the accompanying drawings, which illustrate, by way of example, the principles of embodiments of the present disclosure.

In a first aspect of the present disclosure, there is provided a method for CG-based transmission at a user equipment. The method comprises: determining one or more synchronization signal and physical broadcast channel blocks (SSBs); determining one or more physical uplink shared channel (PUSCH) resources mapped to the determined one or more SSBs, according to mapping information on mappings between a set of SSBs and a set of PUSCH resources; and transmitting to a network node, data of the CG based transmission by utilizing the determined one or more PUSCH resources.

In some embodiments, the method may further comprise: receiving from a network node, a message indicating the mapping information, wherein the message indicates a PUSCH resource associated with an SSB.

In some embodiments, the method may further comprise: obtaining configuration of a number of SSBs to be mapped to a PUSCH resource; obtaining configuration of a number of PUSCH resources available for the CG based transmission; and deriving one or more PUSCH resources associated with each SSBs, according to a predefined mapping rule.

In some embodiments, in the mappings, an SSB in the set of SSBs may be mapped to a PUSCH resource in the set of PUSCH resources according to at least one of the following: demodulation reference signal (DMRS) configuration of PUSCH transmission, sounding reference signal (SRS) configuration, one or more PUSCH occasion in one CG period, PUSCH occasions in multiple CG periods, hybrid automatic repeat request (HARQ) process, and one or multiple CG configuration.

In some embodiments, the set of PUSCH resources comprise DMRS resources configured for the CG based transmission, and different SSBs in the set of SSBs are mapped to different DMRS resources. The DMRS resources may comprise one or more DMRS ports, and/or one or more DMRS sequences.

In some embodiments, whether the DMRS resources comprise multiple DMRS sequences depends on whether transform precoding is enabled for PUSCH transmission.

In some embodiments, when the transform precoding is enabled, an SSB may be mapped to a DMRS sequence according to at least one of the following parameters: a cyclic shift, a sequence group index, and a sequence number. A set of cyclic shift values may be configured or predetermined for a generation of a set of DMRS sequences. A sequence group index and/or sequence number may be predetermined or is a function of an SSB index. A sequence group pattern and/or a sequence number may be predetermined for generation of multiple DMRS sequences.

In some embodiments, when transform precoding is disabled, different SSBs in the set of SSBs may be mapped to different PUSCH resources in the sets of PUSCH resources according to DMRS configuration of transmission of the physical uplink channel, and the DMRS configuration comprises at least one of the following parameters: a DMRS sequence scrambling identifier (ID), a number of the DMRS sequence scrambling ID, and a DMRS port ID.

In some embodiments, an SSB in the set of SSBs may be mapped to multiple DMRS ports.

In some embodiments, an SSB in the set of SSBs may be mapped to a PUSCH resource in the set of PUSCH resources according to at least one of the following: an SRS resource index, precoding information, and information on a number of layers.

In some embodiments, the set of PUSCH resources may comprise PUSCH occasions in multiple CG periods, and one or more SSBs in the set of SSBs are mapped to one or more PUSCH resources in the multiple CG periods. The one or more SSBs in the set of SSBs may be mapped to PUSCH occasions in the one or more CG periods, according to a mapping rule between one or more SSB indexes and indexes of the one or more CG periods.

In some embodiments, the set of PUSCH resources may comprise multiple PUSCH occasions in a CG period, and one or more different SSBs in the set of SSBs is mapped to one or more different PUSCH occasions in the CG period. In some embodiments, multiple SSBs in the set of SSBs may be mapped to the one or more different PUSCH occasions by associating the one or more different PUSCH occasions to the multiple SSBs in the set of SSBs in an order of consecutive PUSCH occasion indexes. In some embodiments, different PUSCH occasions may be taken from the multiple PUSCH occasions in at least one of the following orders: an order of frequency resource indexes of the different PUSCH occasions, and an order of the different PUSCH occasions in time domain.

In some embodiments, an SSB in the set of SSBs may be mapped to a group of PUSCH occasions from the multiple PUSCH occasions, and the group of PUSCH occasions comprises more than one PUSCH occasions with consecutive indexes. Different groups of PUSCH occasions may be taken from the multiple PUSCH occasions in at least one of the following orders: an order of frequency resource indexes of the different groups of PUSCH occasions, and an order of the different groups of PUSCH occasions in time domain.

In some embodiments, more than one SSBs in the set of SSBs may be mapped to one or more same PUSCH occasions in the CG period.

In some embodiments, multiple SSBs in the sets of SSBs may be mapped to multiple DMRS resources by associating the multiple DMRS resources to the multiple SSB in the set of SSBs in an order of consecutive DMRS resource indexes. In some embodiments, the order of consecutive DMRS resource indexes may be determined according to DMRS resource indexes within a PUSCH occasion, frequency resource indexes of PUSCH occasions, and indexes of PUSCH occasions in time domain.

In some embodiments, the set of PUSCH resources may comprise PUSCH resources in multiple HARQ processes, and an SSB in the set of SSBs is mapped to one or more HARQ processes of the multiple HARQ processes.

In some embodiments, the set of PUSCH resources may comprise multiple PUSCH resources in a HARQ process, and different SSBs in the set of SSBs are mapped to different PUSCH resources in the HARQ process.

In some embodiments, the set of PUSCH resources may comprise PUSCH resources configured by multiple CG configuration, and one or more different SSB indexes are mapped to PUSCH resources configured by different CG configuration.

In some embodiments, the set of PUSCH resources may comprise PUSCH resources configured by multiple CG configuration, and the set of SSBs are mapped to PUSCH resources configured by each CG configuration.

In some embodiments, the set of PUSCH resources may be configured by one CG configuration.

In some embodiments, the set of PUSCH resources may comprise PUSCH occasions and/or DMRS resources, and the method further comprises: invalidating a PUSCH resource that fulfills at least one of the following conditions: the PUSCH resource is not mapped to any SSBs, and the PUSCH resource collides with a downlink symbol or slot. The invalidated PUSCH resource may be not used for mapping to the set of SSBs.

In some embodiments, multiple PUSCH resources in the set of PUSCH resources which are configured to have a same pattern in time domain, may be multiplexed in frequency domain. In some embodiments, the multiple PUSCH resources in the set of PUSCH resources may be mapped to a same SSB in the set of SSBs.

In some embodiments, multiple PUSCH resources in the set of PUSCH resources which are configured to have a same time and frequency resource with different DMRS resources, may be mapped to a same SSB in the set of SSBs.

In some embodiments, multiple SSB indexes may be mapped to one or more same PUSCH resources in the set of PUSCH resources.

In some embodiments, the CG based transmission may be a CG-based small data transmission.

In a second aspect of the present disclosure, there is provided a method for CG-based transmission at a network node. The method comprises: receiving from a user equipment, data of the CG based transmission; determining one or more PUSCH resources utilized by the CG based transmission; and determining one or more synchronization signal and physical broadcast channel blocks (SSBs) mapped to the determined one or more PUSCH resources, according to mapping information on mappings between a set of SSBs and a set of PUSCH resources.

In some embodiments, the method may further comprise: transmitting to the user equipment, a message indicating the mapping information, wherein the message indicates a PUSCH resource associated with an SSB.

In some embodiments, the method may further comprise: transmitting to the user equipment, information by utilizing the determined one or more SSBs.

The mappings between a set of SSBs and a set of PUSCH resources may be configured in a similar way as described with reference to the first aspect.

In a third aspect of the present disclosure, there is provided an apparatus. The apparatus may comprise a processor and a memory coupled to the processor. The memory may contain instructions executable by the processor, whereby the apparatus is operative to perform any step of the method according to the first aspect of the disclosure

In a fourth aspect of the present disclosure, there is provided an apparatus. The apparatus may comprise a processor and a memory coupled to the processor. The memory may contain instructions executable by the processor, whereby the apparatus is operative to perform any step of the method according to the second aspect of the disclosure.

In a fifth aspect of the present disclosure, there is provided a computer-readable medium having computer program codes embodied thereon which, when executed on a computer, cause the computer to perform any step of the method according to the first aspect of the present disclosure.

In a sixth aspect of the present disclosure, there is provided a computer-readable medium having computer program codes embodied thereon which, when executed on a computer, cause the computer to perform any step of the method according to the second aspect of the present disclosure.

According to the various aspects and embodiments as mentioned above, it can enhance efficiency for CG-based transmission.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 illustrates an example of PUSCH resources pre-configured by using Configured Grant Type 1 scheme;

FIG. 2 illustrates an example of SSB multi-beam sweeping;

FIG. 3 illustrates single-symbol or double-symbol based DMRS;

FIG. 4 illustrates frequency mapping of DMRS

FIG. 5 illustrates OFDM symbol mapping of DMRS within a slot;

FIG. 6 illustrates DMRS ports multiplexing;

FIG. 7 illustrates an example of Double-symbol Type 1 DMRS ports multiplexing with both FD-OCC and TD-OCC;

FIG. 8 illustrate a flowchart of a method for CG based transmission at a user equipment according to some embodiments of the present disclosure;

FIG. 9 illustrates a flowchart of a method for CG based transmission at a network node according to some embodiments of the present disclosure;

FIG. 10 illustrates an example of mapping different SSBs to different set of cyclic shifts (CS) IDs, according to some embodiments of the present disclosure;

FIG. 11 illustrates an example of mapping different SSBs to PUSCH occasions in different CG periods, according to some embodiments of the present disclosure;

FIGS. 12, 13, 14 and 15 illustrate an example of mapping different SSBs to multiple PUSCH occasions per CG periods, according to some embodiments of the present disclosure;

FIG. 16 illustrates an example of mapping different SSBs to multiple PUSCH occasions per CG periods, according to some embodiments of the present disclosure;

FIG. 17 illustrates an example of mapping multiple SSBs to one PUSCH occasion per CG periods, according to some embodiments of the present disclosure;

FIG. 18 illustrates an example of mapping different SSBs to different DMRS configurations and different PUSCH occasions per CG period, according to some embodiments of the present disclosure;

FIG. 19 illustrates an example of the SSBs to CG resources mapping patterns for multiple SDT UEs, according to some embodiments of the present disclosure;

FIG. 20 is a block diagram illustrating an apparatus according to some embodiments of the present disclosure;

FIG. 21 are block diagrams illustrating apparatus according to some embodiments of the present disclosure;

FIG. 22 are block diagram illustrating apparatus according to some embodiments of the present disclosure;

FIG. 23 is a block diagram illustrating a telecommunication network connected via an intermediate network to a host computer in accordance with some embodiments of the present disclosure;

FIG. 24 is a block diagram illustrating a host computer communicating via a base station with a UE over a partially wireless connection in accordance with some embodiments of the present disclosure;

FIG. 25 is a flowchart illustrating a method implemented in a communication system, in accordance with an embodiment of the present disclosure;

FIG. 26 is a flowchart illustrating a method implemented in a communication system, in accordance with an embodiment of the present disclosure:

FIG. 27 is a flowchart illustrating a method implemented in a communication system, in accordance with an embodiment of the present disclosure; and

FIG. 28 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols. and/or any other protocols either currently known or to be developed in the future.

The term “user equipment” refers to any end device that can access a communication network and receive services therefrom. By way of example and not limitation, the user equipment may refer to a UE, a terminal device or other suitable devices. The UE may be, for example, a subscriber station, a portable subscriber station, a mobile station (MS) or an access terminal (AT). The user equipment may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a user equipment may also be called an IoT device and represent a machine or other device that performs monitoring, sensing and/or measurements etc., and transmits the results of such monitoring, sensing and/or measurements etc. to another terminal device and/or a network equipment. The user equipment may in this case be a machine-to-machine (M2M) device, which may in a 3rd generation partnership project (3GPP) context be referred to as a machine-type communication (MTC) device.

As one particular example, the user equipment may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a user equipment may represent a vehicle or other equipment, for example, a medical instrument that is capable of monitoring, sensing and/or reporting etc. on its operational status or other functions associated with its operation.

As used herein, the term “a set of” components means that there are one or more components in one set. For example, a set of SSBs refers to one set in which there may be only one SSB, or in which there may be a plurality of SSBs. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

In the following description and claims, unless defined otherwise, all technical and scientific terms used herein have the same meaning as commonly understood by one of ordinary skills in the art to which this disclosure belongs. For example, the term “user equipment” used herein may refer to any terminal device or user equipment (UE) having wireless communication capabilities, including but not limited to, mobile phones, cellular phones, smart phones, or personal digital assistants (PDAs), portable computers, image capture devices such as digital cameras, gaming devices, music storage and playback appliances, wearable devices, vehicle-mounted wireless device and the like. In the following description, the terms “terminal device”, “user equipment” and “UE” may be used interchangeably. Similarly, the term “network node” may represent any network functionality in a 5G network.

This disclosure focuses on schemes for the CG based transmission, such as CG based small data transmission (SDT). A configuration of CG resource to be used for small data transmission of a UE in uplink can be contained in the RRC Release message. The configuration may be only type 1 CG with no contention resolution procedure for CG. A configuration of CG resources may include one type 1 CG configuration. The configuration of CG resources for small data transmission of a UE is valid only in a same serving cell. A UE can use CG based SDT if at least the following criteria are fulfilled: (1) user data is smaller than a data volume threshold: (2) CG resource is configured and valid; (3) the UE has valid timing advance (TA).

An association between CG resources and SSBs is required for CG-based SDT. One scheme is considered to send an explicit configuration of the association to a UE with a RRC Release message. A SS-RSRP (synchronization signals-reference signal received power) threshold can be configured for a SSB selection. A UE can select one of SSBs with SS-RSRP above the threshold. Then, a CG resource associated with the selected SSB can be selected for uplink data transmission. However, this scheme would consume many transmission resources.

The present disclosure provides different schemes for determining the association between one or more SSBs and one or more resources for CG based transmission.

The CG based transmission can be performed in PUSCH (physical uplink shared channel), such as CG type 1 PUSCH transmission. The CG resources on PUSCH (also referred to as CG configured PUSCH) are the PUSCH resources that configured in advance for the UE. In an example. when there is uplink data available at a UE's buffer, it can immediately start uplink transmission using the pre-configured PUSCH resources, without waiting for an uplink grant from a gNB, thus reducing the latency. NR supports CG type 1 PUSCH transmission and CG type 2 PUSCH transmission. For both two types, the PUSCH resources (e.g. time and frequency allocation, periodicity, etc.) are preconfigured via dedicated RRC signaling. The CG type 1 PUSCH transmission is activated/deactivated by RRC signaling, while the CG type 2 PUSCH transmission is activated/deactivated by an uplink grant using downlink control information (DCI) signaling.

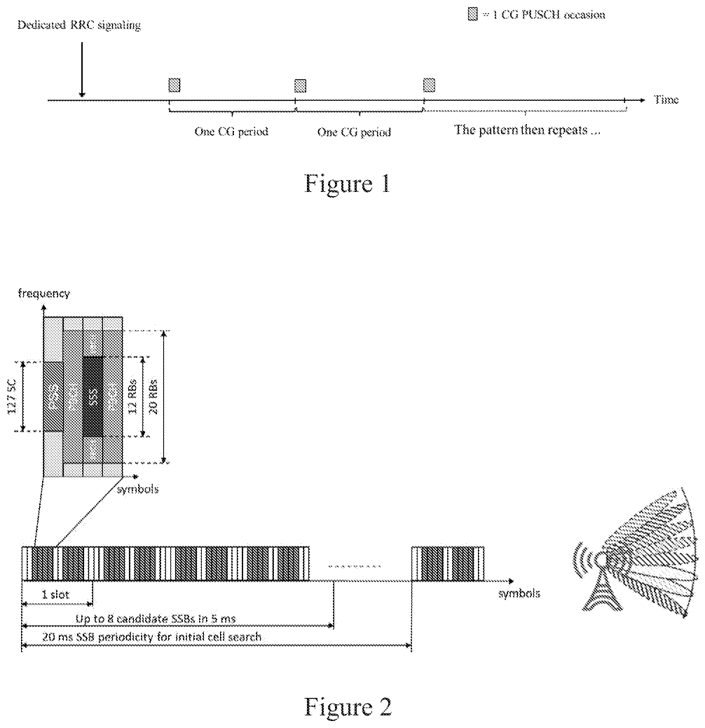

FIG. 1 illustrates an example of PUSCH resources pre-configured by using CG type 1 scheme. As shown in FIG. 1, for CG-based transmission, the PUSCH resources (e.g. time and frequency allocation, periodicity for UL transmission, etc.) are preconfigured via dedicated RRC signaling.

Beamforming is important for improving the coverage of synchronization signals (SSs) and physical broadcast channel (PBCH) block (referred to as SSB in 3GPP) transmission, especially for compensating the high path loss in high carrier frequency bands. To support beamforming and beam-sweeping for SSB transmission, in NR, a cell can transmit multiple SSBs in different narrow-beams in a time multiplexed fashion. The transmission of these SS/PBCH blocks is confined to a half frame time interval (5 ms). FIG. 2 illustrates an example of SSB beam sweeping when the system is operating at frequency range 1 (FR 1).

The maximum number of SSBs within a half frame (i.e., 5 ms), denoted by L, depends on the frequency band, and it is defined as follows:
For carrier frequencies smaller than or equal to 3 GHz, L=4;
For carrier frequencies within FR1 larger than 3 GHz, L=8;
For carrier frequencies within FR2, L=64.

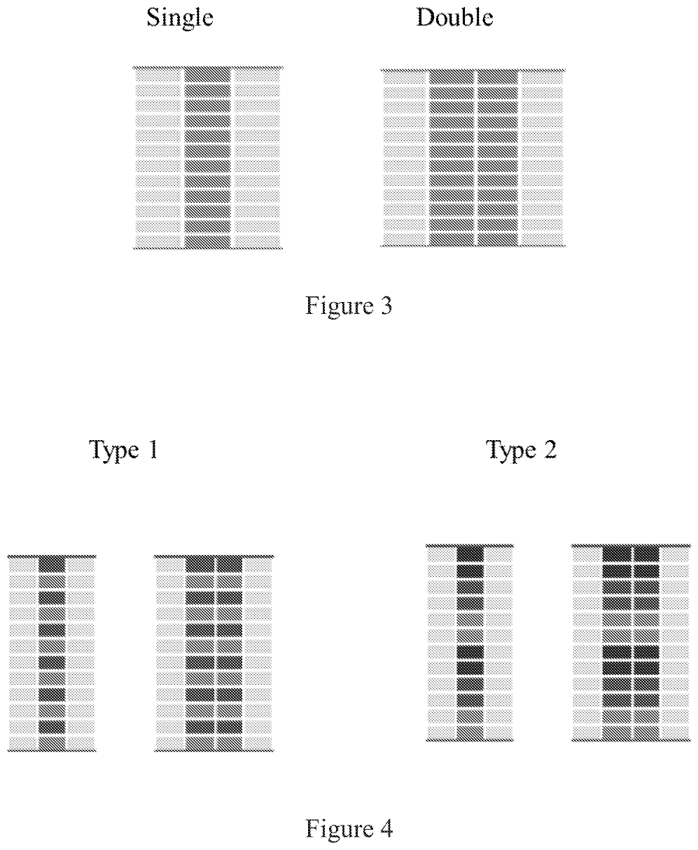

PUSCH is always transmitted with demodulation reference signal (DMRS), which is used by a gNB for channel estimation and PUSCH decoding. In NR, DMRS design can be categorized as below in different aspects. As is shown in FIG. 3, DMRS can be either single-symbol or double-symbol based, where double symbol based is only used for dedicated PDSCH and PUSCH transmissions.

Frequency mapping of DMRS can be seen in FIG. 4, where 2 types of mapping is defined. Before RRC connection, DMRS Type 1 is used. DMRS Type 1 is comb based with 2 CDM (Code Division Multiplexing) groups. DMRS Type 2 is non-comb based with 3 CDM* groups.

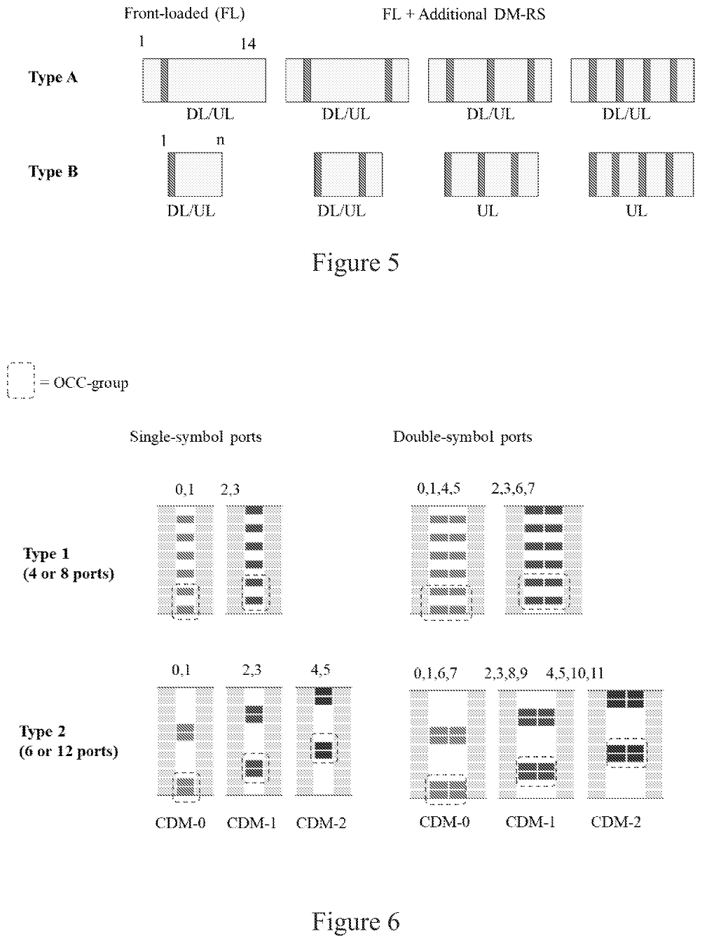

The OFDM Symbol mapping of DMRS to symbols within a slot can be seen in FIG. 5, where the mapping depends on the scheduling type. The scheduling type is dynamically indicated in the DCI that schedules the PDSCH or PUSCH transmission.

Type A is slot based scheduling. where DMRS starts in symbol 3 or 4 from slot boundary (depending on configuration indication in PBCH).

Type B is non-slot-based scheduling, where DMRS starts in PDSCH (physical downlink share channel) or PUSCH symbol 1 (unless it collides with a PDCCH (Physical Downlink Control Channel), in which case DMRS is moved to the first available symbol later in time).

As seen in FIG. 5, additional DMRS symbols (e.g. 1, 2 or 3 additional DMRS symbols) could be configured. By default, two additional symbols are configured (e.g. to be used before RRC configuration). The two additional symbols can be changed for dedicated PDSCH and PUSCH transmissions. The default of two additional symbols is always used when scheduled by the fallback DCI formats 0_0 and 1_0. In addition, FIG. 6 shows the nominal DMRS patterns, assuming the nominal full length slot (i.e. 14 symbols for Type A) and if the duration of PDSCH or PUSCH is shorter, then DMRS symbols are dropped. For example, even if two additional symbols (i.e. in total three symbols) are configured, the actual number of DMRS symbols used for a transmission can be fewer if the PDSCH or PUSCH duration is less than the nominal length.

DMRS port multiplexing can be illustrated in FIG. 6, wherein maximum 4 or 8 ports can be multiplexed with type 1 DMRS and maximum 6 or 12 ports can be multiplexed with type 2 DMRS for single and double symbol DMRS, respectively. Both frequency division multiplexing (FDM), and frequency domain orthogonal cover code (FD-OCC) as well as time domain orthogonal cover code (TD-OCC) can be used to separate the orthogonal antenna ports.

OCC shall be FD-OCC only for single symbol DMRS, and shall be both FD-OCC and TD-OCC for multiplexing of the DMRS ports for 2 symbol DMRS.

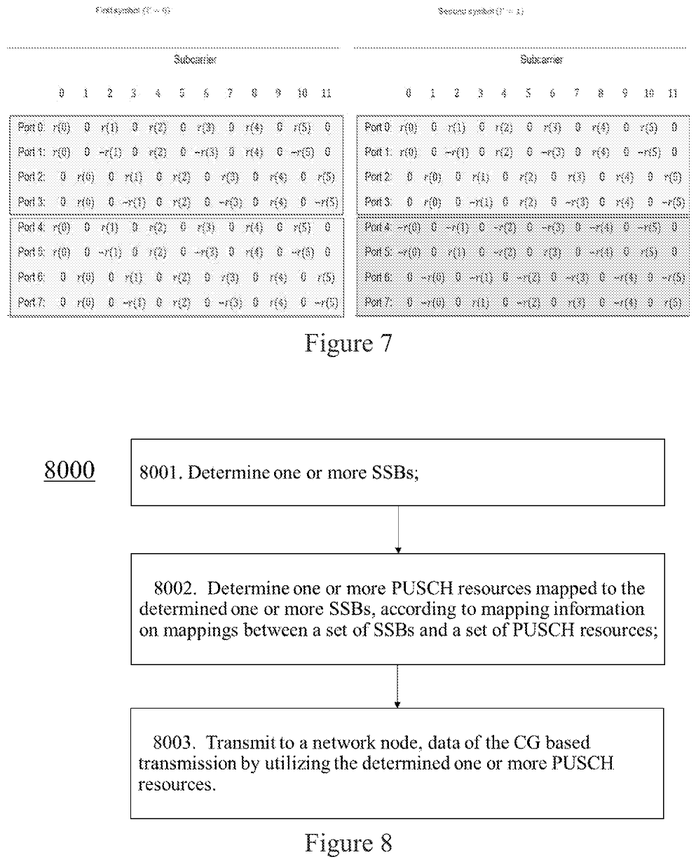

FIG. 7 provides an example of double-symbol Type 1 DMRS ports multiplexing with both FD-OCC and TD-OCC, where r(i) is one sample of the DMRS sequence, and one PRB is illustrated on 2 OFDM symbols with DMRS. As can be seen, 2 OCC code in frequency domain, 2 OCC code in time domain, and 2 CDM groups provide 8 DMRS ports.

DMRS can be transmitted in an orthogonal fashion by transmitting the DMRS in REs (resource elements) not occupied by other DMRSs (i.e. by FDM) or using a different orthogonal cover code (OCC) from DMRSs that occupy the same REs. Since the number of orthogonal DMRSs is limited by the number of REs that the DMRS occupies, it is desirable to support non-orthogonal DMRSs as well to increase the multiplexing capacity. DMRS generation in NR supports both orthogonal and non-orthogonal DMRS generation, as can be understood by, e.g., 3GPP TS 38.211 V16.3.0, sections 6.4.1.1.1.1 and 6.4.1.1.1.2, which are incorporated in this disclosure below. Here is it shown that the sequence r(i) can be configured differently to different UEs, hence even if they use the same FDM, TD-OCC and FD-OCC, they can be separated by a use of different sequences r(i).

### 6.4.1.1.1.1 Sequence Generation When Transform Precoding is Disabled

If transform precoding for PUSCH is not enabled, the sequence r(n) shall be generated according to

$$r ( n ) = \frac{1}{\sqrt{2}} ( 1 - 2 \cdot c ( 2 n ) ) + j \frac{i}{\sqrt{2}} ( 1 - 2 \cdot c ( 2 n + 1 ) ) .$$

where the pseudo-random sequence c(i) is defined in clause 5.2.1. The pseudo-random sequence generator shall be initialized with

$${c}_{init} = ( {2}^{17} ( {N}_{symb}^{slot} {n}_{s , f}^{μ} + l + 1 ) ( 2 {N}_{ID}^{{\overline{n}}_{SCID}^{\overline{λ}}} + 1 ) + {2}^{17} ⌊ \frac{\overline{λ}}{2} ⌋ + 2 {N}_{ID}^{{\overline{n}}_{SCID}^{\overline{λ}}} + {\overline{n}}_{SCID}^{\overline{λ}} ) mod {2}^{31}$$

where l is the OFDM symbol number within the slot, n_{s,f}^{μ} is the slot number within a frame, and
N_{ID}⁰, N_{ID}¹∈{0,1, . . . ,65535} are given by the higher-layer parameters scramblingID0 and scramblingID1, respectively, in the DMRS-UplinkConfig IE if provided and the PUSCH is scheduled by DCI format 0_1 or 0_2, or by a PUSCH transmission with a configured grant;
N_{ID}⁰∈{0,1, . . . ,65535} is given by the higher-layer parameter scramblingID0 in the DMRS-UplinkConfig IE if provided and the PUSCH is scheduled by DCI format 0_0 with the CRC scrambled by C-RNTI, MCS-C-RNTI, or CS-RNTI;
N_{ID}⁰, N_{ID}¹∈{0,1, . . . ,65535} are, for each msgA PUSCH configuration, given by the higher-layer parameters msgA-ScramblingID0 and msgA-ScramblingID1, respectively, in the msgA-DMRS-Configuration IE if provided and the PUSCH transmission is triggered by a Type-2 random access procedure as described in clause 8.1A of [5, TS 38.213];
N_{ID}^{\ddot{n}}^{_{SCID}}^{^{λ̅}}=N_{ID}^{cell} otherwise;
n̅_{SCID}^{λ̅} and λ̅ are given by
   if the higher-layer parameter dmrs-Uplink-r16 in the DMRS-UplinkConfig IE is provided

$$\begin{matrix}{\overline{n}}_{SCID}^{\overline{λ}} = \{ \begin{matrix}{n}_{SCID} & λ = 0 or λ = 2 \\ 1 - {n}_{SCID} & λ = 1\end{matrix} \\ \overline{λ} = λ\end{matrix}$$

where λ is the CDM group defined in clause 6.411.3.
otherwise

n̅_{SCID}^{λ̅}=n_{SCID}

λ̅=0

The quantity n_{SCID}∈{0,1} is
indicated by the DM-RS initialization field, if present, either in the DCI associated with the PUSCH transmission if DCI format 0_1 or 0_2, in [4, TS 38.212] is used;
indicated by the higher layer parameter dmrs-SeqInitialization, if present, for a Type 1 PUSCH transmission with a configured grant or for a PUSCH transmission of Type-2 random access process in [5, TS 38.213];
determined by the mapping between preamble(s) and a PUSCH occasion and the associated DMRS resource for a PUSCH transmission of Type-2 random access process in [5, TS 38.213];
otherwise n_{SCID}=0.

### 6.4.1.1.1.2 Sequence Generation When Transform Precoding is Enabled

If transform precoding for PUSCH is enabled, the reference-signal sequence r(n) shall be generated according to

r(n)=r_{u,v}^{(α,δ)}(n)

n=0, 1, . . . , M_{sc}^{PUSCH}/2^{δ}−1

where r_{u,v}^{(α,δ)}(n) with δ=1 depends on the configuration:
if the higher-layer parameter dmrs-UplinkTransformPrecoding-r16 is configured, π/2-BPSK modulation is used for PUSCH, and the PUSCH transmission is not a msg3 transmission, and the transmission is not scheduled using DCI format 0_0 in a common search space, r_{u,v}^{(α,δ)}(n) is given by clause 5.2.3 with cᵢₙᵢₜ given by

cᵢₙᵢₜ=(2¹⁷(N_{symb}^{slot}n_{s,f}^{μ}+l+1)(2N_{ID}ⁿ^{_{SCID}}+1)+2N_{ID}ⁿ^{_{SCID}}+n_{SCID})mod 2³¹

where n_{SCID}=0 unless given by the DCI according to clause 7.3.1.1.2 in [4, TS38.212] for a transmission scheduled by DCI format 0_1, or given by the DCI according to clause 7.3.1.1.3 in [4, TS38.212] for a transmission scheduled by DCI format 0_2 if the antenna ports field in the DCI format 0_2 is not 0 bit, or given by the higher-layer parameter antennaPort for a PUSCH transmission scheduled by a type-1 configured grant; and
N_{ID}⁰, N_{ID}¹∈{0,1, . . . , 65535} are given by the higher-layer parameters pi2BPSK-ScramblingID0 and pi2BPSK-ScramblingID1, respectively, in the DMRS-UplinkConfig IE if provided and the PUSCH is scheduled by DCI format 0_1, or by DCI format 0_2 if the antenna ports field in the DCI format 0_2 is not 0 bit, or by a PUSCH transmission with a configured grant;
N_{ID}⁰∈{0,1, . . . , 65535} is given by the higher-layer parameter pi2BPSK-ScramblingID0 in the DMRS-UplinkConfig IE if provided and the PUSCH is scheduled by DCI format 0_0 with the CRC scrambled by C-RNTI, MCS-C-RNTI, or CS-RNTI, or by DCI format 0_2 if the antenna ports field in the DCI format 0_2 is 0 bit;
N_{ID}ⁿ^{_{SCID}}=N_{ID}^{cell} otherwise;
otherwise, r_{u,v}^{(α,δ)}(n) is given by clause 5.2.2 with α=0.

The sequence group u=(f_{gh}+n_{ID}^{RS}) mod 30, where n_{ID}^{RS} is given by
n_{ID}^{RS}=n_{ID}^{PUSCH} if n_{ID}^{PUSCH} is configured by the higher-layer parameter nPUSCH-Identity in the DMRS-UplinkConfig IE, and
   the higher-layer parameter dmrs-UplinkTransformPrecoding-r16 is not configured or the higher-layer parameter dmrsUplinkTransformPrecoding-r16 is configured and π/2-BPSK modulation is not used for PUSCH, and
   the PUSCH is neither scheduled by RAR UL grant nor scheduled by DCI format 0_0 with CRC scrambled by TC-RNTI according to clause 8.3 in [5, TS 38.213];
n_{ID}^{RS}=N_{ID}ⁿ^{_{SCID}} if the higher-layer parameter dmrs-UplinkTransformPrecoding-r16 is configured, π/2-BPSK modulation is used for PUSCH, the PUSCH transmission is not a msg3 transmission, and the transmission is not scheduled using DCI format 0_0 in a common search space;
n_{ID}^{RS}=N_{ID}^{cell} otherwise
   where f_{gh} and the sequence number v are given by:
if neither group, nor sequence hopping is enabled

f_{gh}=0

v=0
if group hopping is enabled and sequence hopping is disabled

$$\begin{matrix}{f}_{gh} = ( {\sum }_{m = 0}^{7} {2}^{m} c ( 8 ( {N}_{symb}^{slot} {n}_{s , f}^{μ} + l ) + m ) ) mod 30 \\ v = 0\end{matrix}$$

where the pseudo-random sequence c(i) is defined by clause 5.2.1 and shall be initialized with cᵢₙᵢₜ=[n_{ID}^{RS}/30] at the beginning of each radio frame
if sequence hopping is enabled and group hopping is disabled

$$\begin{matrix}{f}_{gh} = 0 \\ v = \{ \begin{matrix}c ( {N}_{symb}^{slot} {n}_{s , f}^{μ} + l ) & if {M}_{ZC} \geq 6 {N}_{sc}^{RB} \\ 0 & otherwise\end{matrix}\end{matrix}$$

where the pseudo-random sequence c(i) is defined by clause 5.2.1 and shall be initialized with cᵢₙᵢₜ=n_{ID}^{RS} at the beginning of each radio frame.

The hopping mode is controlled by higher-layer parameters:
for PUSCH transmission scheduled by RAR UL grant or by DCI format 0-0 with CRC scrambled by TC-RNTI, sequence hopping is disabled and group hopping is enabled or disabled by the higher-layer parameter groupHoppingEnabledTransformPrecoding;
for all other transmissions, sequence hopping and group hopping are enabled or disabled by the respective higher-layer parameters sequenceHopping and sequenceGroupHopping if these parameters are provided, otherwise, the same hopping mode as for Msg3 shall be used.

The UE is not expected to handle the case of combined sequence hopping and group hopping. The quantity 1 above is the OFDM symbol number except for the case of double-symbol DMRS in which case 1 is the OFDM symbol number of the first symbol of the double-symbol DMRS.

Considering first the DMRS when transform precoding is not used, since the sequence c(i) is pseudo random, it can be said to scramble the DMRS sequence generating sequence r( ). Furthermore, initializing c(i) with a different initialization value cᵢₙᵢₜ from that of another DMRS will cause the two DMRSs corresponding to a given antenna port to be non-orthogonal. Since cᵢₙᵢₜ depends on N_{ID}⁰ and/or N_{ID}¹ and both of these parameters can be signaled to each UE independently of other UEs, they can be said to be scrambling IDs for the DMRS used by the UE. When N_{ID}⁰ or N_{ID}¹ used by a UE is different from the N_{ID}⁰ or N_{ID}¹ used by another UE, the DMRS sequences of the two UEs for a given DMRS port are not orthogonal for a given antenna port. However, if N_{ID}⁰ and N_{ID}¹ are the same as the N_{ID}⁰ and N_{ID}¹ used by another UE, transmissions by the UEs on different DMRS ports will be orthogonal according to the construction of DMRS in 3GPP TS 38.211 V16.3.0.

Next, considering the DMRS when transform precoding is used, since the sequence r_{u,v}^{(α,δ)}(m) is Zadoff-Chu sequence, it can be said to apply different cyclic shifts and root values of the root sequence to generate sequence r( ).

Furthermore, considering a same cyclic shift, applying different groups, i.e. u values for two DMRSs corresponding to a given antenna port will generate 2 non-orthogonal DMRS sequences. Since u depends on f_{gh} and n_{ID}^{RS} and both of these parameters can be signaled by dedicated signalling from network to each UE independently of other UEs, they can be interpreted to be scrambling IDs for the DMRS used by the UE. When f_{gh} and n_{ID}^{RS} used by a UE is different from the f_{gh} and n_{ID}^{RS} used by another UE, the DMRS sequences of the two UEs for a given DMRS port are not orthogonal for a given antenna port. However, if f_{gh} and n_{ID}^{RS} are the same as the f_{gh} and n_{ID}^{RS} used by another UE, transmissions by the UEs on different DMRS ports will be orthogonal according to the construction of DMRS. e.g., in 3GPP TS 38.211 V16.3.0.

Considering different cyclic shift values v within a same group u, v can be called as to be scrambling IDs for the DMRS used by UE.

So, in general, the different combinations of {u, v} can be interpreted as and thus be called as to be scrambling IDs for the DMRS used by UE when transform precoding is used.

As discussed above, the present disclosure provides solutions for improving transmission efficiency for CG-based transmission by establishing an association between SSBs and resources for the CG transmission. The present disclosure proposes different schemes for configuration of association/mapping between the one or more CG resources and one or more SSBs (which is also referred to as CG configured PUSCH association) for CG-based SDT. In this regard, different SSBs can be mapped to at least one of the following: DMRS resources, PUSCH occasions in one CG period, PUSCH occasions in multiple CG periods, HARQ processes, CG configurations, SRS resource indexes, precoders and number of layers.

The proposed methods in the present disclosure enable multi-beam operation for CG-based SDT. The methods can minimize an amount of resources need to be reserved for CG PUSCH resource(s) and the signaling overhead for a gNB to informing the UE of such configuration, while providing the necessary flexibility for the SSB(s) to CG resource(s) mapping.

FIG. 8 illustrates a flowchart of a method 8000 for CG based transmission at a user equipment (e.g. UE), according to some embodiments of the present disclosure. As shown in FIG. 8, the method 8000 comprises: determining one or more synchronization signal and physical broadcast channel blocks (SSBs), at block 8001. Then, the method proceeds to determine one or more physical uplink shared channel (PUSCH) resources mapped to the determined one or more SSBs, according to mapping information on mappings between a set of SSBs and a set of PUSCH resources, as shown at block 8002. The method further comprises transmitting to a network node, data of the CG based transmission by utilizing the determined one or more PUSCH resources, as shown at block 8003.

Although not shown in FIG. 8, the method 8000 may further comprise: receiving from a network node, a message indicating the mapping information, wherein the message indicates a PUSCH resource associated with an SSB.

In some embodiments, the method 8000 may further comprise: obtaining a configuration of a number of SSBs to be mapped to a PUSCH resource; obtaining a configuration of a number of PUSCH resources available for the CG based transmission; and deriving one or more PUSCH resources associated with each SSBs, according to a predefined mapping rule.

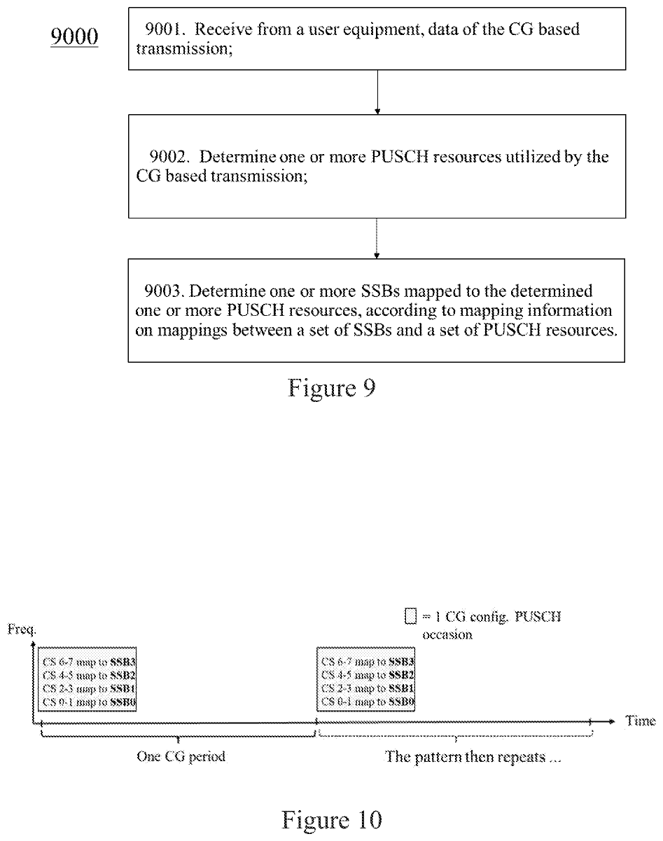

FIG. 9 illustrates a flowchart of a method for CG based transmission at a network node, e.g., a gNB, according to some embodiments of the present disclosure. As shown in FIG. 9, the method 9000 comprises: receiving from a user equipment, data of the CG based transmission at block 9001. Then, the mothed 9000 proceeds to determine one or more PUSCH resources utilized by the CG based transmission, as shown at block 9002. Then, the mothed 9000 proceeds to determine one or more synchronization signal and physical broadcast channel blocks (SSBs) mapped to the determined one or more PUSCH resources, according to mapping information on mappings between a set of SSBs and a set of PUSCH resources, as shown at block 9003.

In some embodiments, the method 9000 may further comprise: transmitting to the user equipment, a message indicating the mapping information, wherein the message indicates a PUSCH resource associated with an SSB.

In some embodiments, the method 9000 may further comprise: transmitting to the user equipment, information by utilizing the determined one or more SSBs.

In some embodiments, a PDSCH (Physical Downlink Share Channel) is transmitted from the network node to the user equipment, for confirmation of the reception of CG configured PUSCH carrying the data of the CG based transmission. When receiving this PDSCH, the user equipment is expected to assume that the DMRS port of the PDSCH is quasi co-located with the SS/PBCH block (also referred to as SSB) the user equipment used for the CG configured PUSCH association, with respect to one or more of Doppler shift, Doppler spread, average delay, delay spread, spatial RX(receive) parameters.

In the mappings, an SSB in the set of SSBs may be mapped to a PUSCH resource in the set of PUSCH resources according to at least one of the following: demodulation reference signal (DMRS) configuration of PUSCH transmission, sounding reference signal (SRS) configuration, one or more PUSCH occasion in one CG period, PUSCH occasions in multiple CG periods, hybrid automatic repeat request (HARQ) process, and one or multiple CG configurations. Various schemes for the mapping according to respective information are described below in detail.

### 1. Mapping Different SSBs to Different DMRS Configurations of the PUSCH Transmission

In some embodiments, different SSBs can be mapped to different DMRS configurations or DMRS resources. A mapping rule can be predefined and known at both the UE side and the gNB side. Therefore, by detecting a DMRS configuration/resource of PUSCH transmission, the gNB can know which SSB is selected by the UE, e.g. by mapping the detected DMRS configuration/resource to a SSB according to the mapping rule.

In one embodiment, the set of PUSCH resources comprise DMRS resources configured for the CG based transmission, and different SSBs in the set of SSBs are mapped to different DMRS resources. A mapping rule between one or more SSBs and DMRS resources of the PUSCH resources configured for CG based transmission is predefined. As an example, when a set of DMRS resources including multiple DMRS ports and multiple DMRS sequences are configured for the CG based transmissions on PUSCH, a mapping in increasing order of DMRS resource indexes within a PUSCH occasion can be defined between these DMRS resources and SSBs, where the DMRS resource index is determined first in an ascending order of a DMRS port index and second in an ascending order of a DMRS sequence index. Here, a PUSCH occasion can be a resource in time domain and a resource in frequency domain configured for PUSCH transmissions.

In an embodiment, the DMRS resources may comprise one or more DMRS ports, and/or one or more DMRS sequences.

In another embodiment, whether the DMRS resources comprises multiple DMRS sequences depends on whether transform precoding is enabled for the PUSCH transmission. In an example, only in case of CP-OFDM, i.e. when transform precoding is disabled, multiple DMRS sequences are supported, while when transform precoding is enabled, only single DMRS sequence is supported. When the transform precoding is enabled for CG PUSCH transmission, the reference-signal sequence r(n) is generated according to

r(n)=r_{u,v}^{(α,δ)}(n)

n=0, 1, . . . , M_{sc}^{PUSCH}/2^{δ}−1

where r_{u,v}^{(α,δ)}(m) is given by clause 5.2.2 of 3GPP TS 38.211 V16.3.0, with δ=1, and α, u, v. (which represent cyclic shift, sequence group index, sequence number, respectively) may be determined with following embodiments.

In some embodiments, if transform precoding is enabled (e.g. DFT-s-OFDM is used) for the PUSCH transmission, the multiple DMRS sequence generation include at least one of the following parameters: cyclic shift (CS), a sequence group index, a sequence number. An SSB may be mapped to a DMRS sequence according to at least one of the above parameters.

FIG. 10 shows an example of mapping 4 different SSBs to 8 different CS IDs of the DMRS associated with a PUSCH transmission. Each CS ID indicate a CS value. As shown in FIG. 10, one SSB can be mapped to two CS IDs. It can be appreciated that, in other examples, one SSB can be mapped to one CS ID, or more than two CS IDs.

In one embodiment, a set of CS values can be configured or predetermined for a generation of a set of DMRS sequences.

In one embodiment, the sequence group index can be predetermined or can be a function of SSB ID. In another embodiment, a sequence group pattern can be predefined for the multiple DMRS sequence generations. For example, 4 SSBs are mapped to 4 DMRS sequences and 1 DMRS port in one PUSCH occasion, the values of sequence group indexes u∈{0, 1, 2, 3} are used for this PUSCH occasion for generating 4 DMRS sequences, and the 4 DMRS sequences with u=0, 1, 2, 3, respectively, can be mapped to the 4 SSBs based on an order of the SSB indexes, e.g. based on an increasing values of SSB indexes. These embodiments are also applicable for a sequence number represented by v in a group. In this regard, the sequence number in a group can be predetermined or can be a function of SSB ID. A sequence number can be predefined for the multiple DMRS sequence generations.

In some embodiments, if transform precoding is disabled (e.g. CP-OFDM is used) for the PUSCH transmission, the DMRS configurations can comprise at least one of the following parameters: DMRS sequence scrambling ID, a number of the DMRS sequence scrambling ID, and DMRS port ID.

As an example, an SSB resource list CGPUSCH-ssb-ResourceList can be signaled from a network side (e.g. a gNB) to a UE. Each entry of SSB resource in the SSB resource list comprises one antenna port, one DMRS sequence initialization value. This indicates that an SSB (indexed by SSB-index) is associated with the antenna port and the DMRS sequence initialization value (which can be optional). For example, the SSB resource list can be carried in a RRC (Radio Resource Control) release message. An exemplary SSB resource list can be specified as follows.

| | |
|---|---|
| CGPUSCH-ssb-ResourceList | SEQUENCE (SIZE(1..maxCGPUSCH-SSB-Resources)) OF |

CGPUSCH-SSB-Resource

| CGPUSCH-SSB-Resource ::= | SEQUENCE { | |
|---|---|---|
| ssb | SSB-Index, | |
| antennaPort | INTEGER (0..31), | |
| dmrs-SeqInitialization | INTEGER (0..1) | OPTIONAL, -- Need R |

}

A field “antennaPort” indicates an antenna port(s) to be used for the configured grant based PUSCH transmission for SDT when the corresponding SSB is selected. The maximum bitwidth of the field “antennaPort” is 5, and it can be set according to tables 7.3.1.1.2-6 to 7.3.1.1.2-23 specified in 3GPP TS38.212 V16.3.0. A field “dmrs-SeqInitialization” indicates the DMRS sequence initialization value. The network configures the “dmrs-SeqInitialization” if transform precoder is disabled. Otherwise, the field is absent.

In these embodiments in which an SSB is mapped to DMRS resources or DMRS configurations, a gNB can try different DMRS candidates to be able to detect the DMRS configuration of a received PUSCH transmission. Comparing to the case of signaling the DMRS configuration of PUSCH transmission directly in the dedicated RRC signaling for CG, these embodiments increase the gNB detection complexity. However, compared to other methods, these embodiments require the least amount of uplink time frequency resources that need to be reserved for CG-based SDT, without causing increase latency.

In an embodiment, a SSB in the set of SSBs can be mapped to multiple DMRS ports. For example, when multi-layer transmission is used for SDT with CG type 1, different SSBs can be mapped to different subset of DMRS ports selected. As an example, when 4 DMRS ports are used for multi-layer transmission, 2 SSBs are transmitted, and 8 DMRS ports are configured, a first SSB can be mapped to the first 4 DMRS ports of the 8 DMRS ports, while a second SSB can be mapped to the second 4 DMRS ports of the 8 DMRS ports.

### 2. Mapping Different SSBs to SRI, Precoder Information and Number of Layer Information

In some embodiments, an SSB can be mapped to a PUSCH resource according to at least one of the following: an SRS resource index, precoding information, and information on a number of layers.

As an example, in the above embodiment regarding an SSB resource list, different SSB resources can be configured in RRC with independent configuration of precoding information, number of layers and SRS resource indicator. An exemplary SSB resource list can be specified as follows.

| | |
|---|---|
| CGPUSCH-ssb-ResourceList | SEQUENCE (SIZE(1..maxCGPUSCH-SSB-Resources)) OF |

CGPUSCH-SSB-Resource

| CGPUSCH-SSB-Resource ::= | SEQUENCE { | |
|---|---|---|
| ssb | SSB-Index, | |
| antennaPort | INTEGER (0..31), | |
| dmrs-SeqInitialization | INTEGER (0..1) | OPTIONAL, -- Need R |
| precodingAndNumberOfLayers | INTEGER (0..63), | |
| srs-ResourceIndicator | INTEGER (0..15) | OPTIONAL, -- Need R |

}

Similarly, in this SSB resources list, a field “antennaPort” indicates the antenna port(s) to be used for the configured grant based PUSCH transmission for SDT when the corresponding SSB is selected. Its maximum bitwidth is 5, according to tables 7.3.1.1.2-6 to 7.3.1.1.2-23 specified in 3GPP TS38.212 V16.3.0. A field “dmrs-SeqInitialization” indicates the DMRS sequence initialization value, and the network configures this field if transformPrecoder is disabled. Otherwise the field is absent.

A field “precodingAndNumberOfLayers” indicates the precoder and the number of layers to be used according to Tables 7.3.1.1.2-2 to 7.3.1.1.2-5 specified in 3GPP TS38.212 V16.3.0. A field “srs-ResourceIndicator” indicates the SRS resource to be used according to Tables 7.3.1.1.2-28 to 7.3.1.1.2-32 specified in 3GPP TS38.212 V16.3.0.

### 3. Mapping Different SSBs to PUSCH Occasions in Different CG Periods

Here, one PUSCH occasion is defined as the time/frequency resource on which a PUSCH is transmitted. One or more SSBs in the set of SSBs are mapped to one or more PUSCH resources in the multiple CG periods. For example, only a single PUSCH occasion can be configured per CG period. Then, different SSBs can be associated with different CG periods. Based on the time when the PUSCH is received from a UE, a gNB can determine a corresponding CG period, and thus know which SSB is selected by the UE.

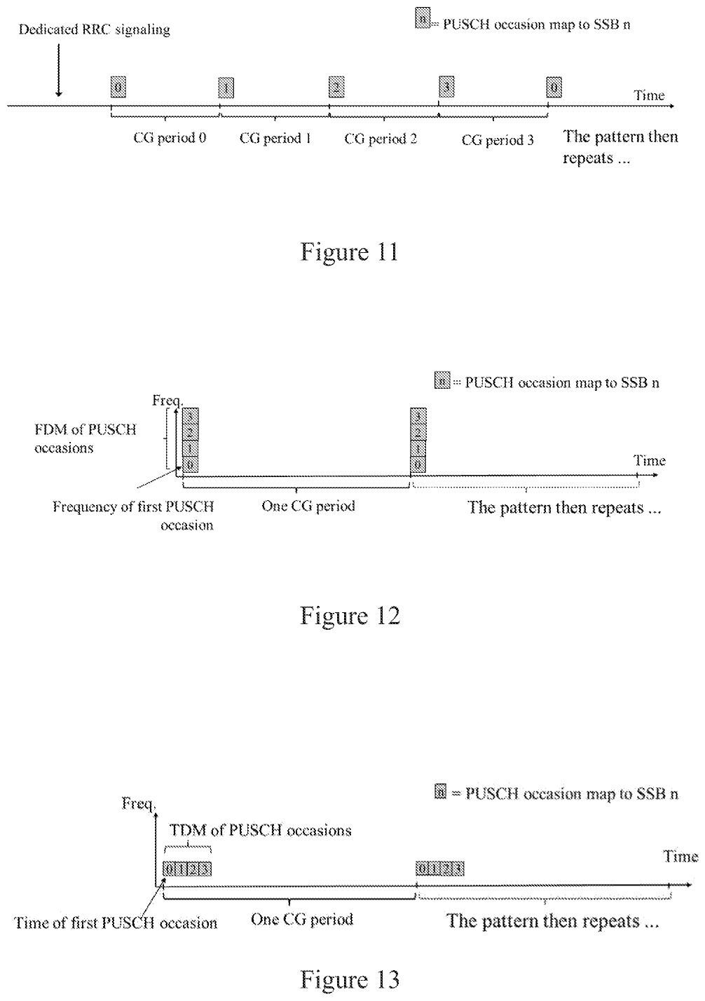

In an embodiment, one or more SSBs in the set of SSBs may be mapped to PUSCH occasions in the one or more CG periods, according to a mapping rule between one or more SSB indexes and indexes of the one or more CG periods. A mapping rule between an SSB and the CG period ID can be predefined. In this way, a selected SSB of a UE performing SDT can indicated by the ID of the CG period in which the PUSCH is transmitted. FIG. 11 illustrates an example of mapping different SSBs to PUSCH occasions in different CG periods. As shown in FIG. 11, there are 4 SSBs to be mapped. There is one PUSCH occasion available for performing SDT per CG period. The SSB ID can be derived by an equation: SSB_ID =CG_period_ID mod number_of_SSBs, wherein number_of_SSBs represents a number of SSBs to be mapped, which is 4 in the example of FIG. 11.

Although only one PUSCH occasion is configured for performing SDT per CG period in the example of FIG. 11, it can be appreciated that more than one PUSCH occasions can be configured for performing SDT per CG period. Although one SSB is associated with only one CG period in the example of FIG. 11, it can be appreciated that more than one CG periods can be associated with one SSB. An association between an SSB and one or more CG periods may mean that the SSB is mapped all PUSCH occasions configured for the CG-based SDT in the one or more CG periods.

For SDTs occurring with low frequency, it is desirable to configure a relatively long CG periodicity to fit its traffic pattern. However, if using the mapping in this scheme for the association between SSB and PUSCH resources configured for CG transmission, then, a UE may need to wait for a very long time to be able to transmit its small data on the PUSCH associated to the selected SSB. This will introduce extra delay for SDT, also the best SSB might change at the time when the UE can start SDT. Therefore, this scheme fits more to a use cases, where a service can tolerant long delays and a radio channel condition between the UE and a gNB is very stable, or when the configured CG period is short. The benefit of scheme is that no additional PUSCH occasion definitions are needed in each CG period, so that existing configured grant type 1 scheduling is enough.

### 4. Mapping Different SSBs to Different PUSCH Occasions per CG Period

In this regard, the set of PUSCH resources to be mapped may comprises PUSCH occasions in a CG period. One or more different SSBs can be mapped to one or more different PUSCH occasions in the CG period. It is assumed that multiple PUSCH occasions can be configured per CG period. Based on the occasion (including time and frequency resources) of the received PUSCH in a CG period, a gNB can know which SSB or subset of SSBs are selected by the UE.

In an embodiment, multiple PUSCH occasions are configured for SDT in a CG configuration period. A mapping rule between an SSB and the PUSCH occasions configured for CG transmission can be defined for SDT (i.e. CG-based SDT). The selected one or more SSBs of a UE for performing SDT can be indicated by the PUSCH occasion on which the small data is transmitted.

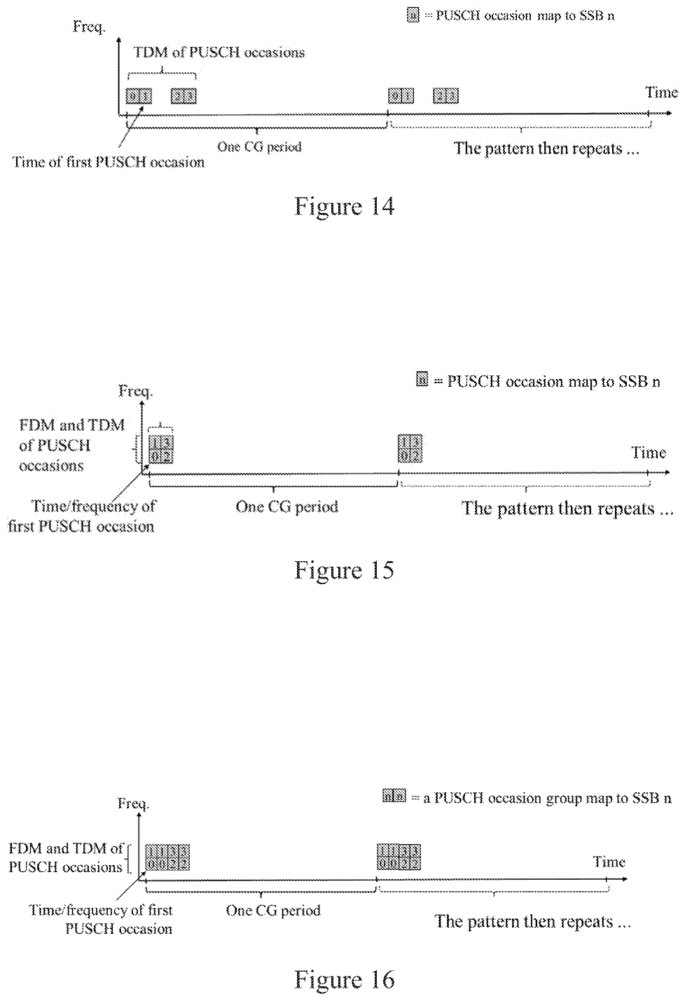

The PUSCH occasions configured for CG-based SDT can be either frequency multiplexed (as shown in FIG. 12), or time multiplexed (as shown in FIG. 13 and FIG. 14), or both time and frequency multiplexed (as shown in FIG. 15). In some embodiments, multiple SSBs in the set of SSBs may be mapped to the one or more different PUSCH occasions by associating the one or more different PUSCH occasions to the multiple SSBs in the set of SSBs in an order of consecutive PUSCH occasion indexes. For example, the mapping between SSB and the PUSCH resources is done by consecutively associating M PUSCH occasions to each SSB, where M can be an integer equal to 1 or larger than 1. In an example, M can be calculated through an equation written as:

M=number_of_PUSCH_occasions_per_CG_period/number_of_SSBs.

“number_of_PUSCH_occasions_per_CG_period” represent a number of PUSCH occasions per CG period, and “number_of_SSBs” represent a number of SSBs to be mapped. In the examples show in FIG. 12, FIG. 13, FIG. 14 and FIG. 15, “number_of_PUSCH_occasions_per_CG_period”=4, “number_of_SSBs”=4, so M=1.

In an embodiment, different PUSCH occasions are taken from multiple PUSCH occasions in a CG period in at least one of the following orders, so as to be mapped to different SSBs: an order of frequency resource indexes of the different PUSCH occasions, and an order of the different PUSCH occasions in the time domain. For example, the PUSCH occasions are taken firstly, in an increasing order of frequency resource indexes for frequency multiplexed PUSCH occasions, and secondly, in increasing order in the time domain.

FIG. 12 illustrates an example of mapping different SSBs to multiple frequency division multiplexed (FDMed) PUSCH occasions per CG period. For example, the number of FDMed PUSCH occasions may be 1, 2, 4, or 8, and the like. As illustrated in FIG. 12, 4 SSBs are mapped to 4 FDMed PUSCH occasions per CG period. The configured PUSCH occasions are continuous in the frequency domain.

FIG. 13 illustrates an example of mapping different SSBs to multiple time division multiplexed (TDMed) PUSCH occasions per CG periods. For example, the number of TDMed PUSCH occasions may be 1, 2, 4, or 8, and the like. As illustrated in FIG. 13, 4 SSBs are mapped to 4 TDMed PUSCH occasions per CG Period. The configured PUSCH occasions are continuous in the time domain.

FIG. 14 illustrates another example of mapping different SSBs to multiple time division multiplexed (TDMed) PUSCH occasions per CG periods. As illustrated in FIG. 14, 4 SSBs are mapped to 4 TDMed PUSCH occasions per CG period, and the configured PUSCH occasions are non-continuous in the time domain.

FIG. 15 illustrates an example of mapping different SSBs to multiple FDMed and TDMed PUSCH occasions per CG periods. As illustrated in FIG. 15, 4 SSBs are mapped to 4 FDM/TDM-ed PUSCH occasions per CG period.

The above examples assume that SDT is transmitted on PUSCH without repetition. However, the scheme can be easily extended to cover the PUSCH repetition case for SDT. In this case, multiple consecutive PUSCH occasions in time are grouped together for repetition, and different SSBs are mapped to different PUSCH occasion groups as shown in FIG. 16. In an example shown in FIG. 16, 4 SSBs are mapped to 4 FDM/TDM-ed PUSCH occasions per CG period.

In some embodiments, multiple consecutive PUSCH occasions in time are grouped together. In an embodiment, an SSB in the set of SSBs may be mapped to a group of PUSCH occasions from the multiple PUSCH occasions, and the group of PUSCH occasions comprises more than one PUSCH occasions with consecutive indexes. For example, the mapping between SSB and the CG configured PUSCH occasions is done by consecutively associating M PUSCH occasion groups to each SSB. M can be calculated as follows:

M=number_of_PUSCH_occasions_per_CG_period/number_of_PUSCH_occasions_per_group/number_of_SSBs.

The value of “number_of_PUSCH_occasions_per_group” indicates a number of PUSCH occasion per group.

In an embodiment, different groups of PUSCH occasions may be taken from the multiple PUSCH occasions in at least one of the following orders: an order of frequency resource indexes of the different groups of PUSCH occasions, and an order of the different groups of PUSCH occasions in time domain. For example, as illustrated in FIG. 16, the PUSCH occasion groups are taken in the following order: firstly, in increasing order of frequency resource indexes for frequency multiplexed PUSCH occasions; secondly, in increasing order in the time domain.

In the examples shown in FIG. 16, number_of_PUSCH_occasions_per_CG_period=8, number_of_PUSCH_occasions_per_group=2, number_of_SSBs=4, so M=1.

In some cases, the set of SSBs are divided into several SSB subsets, with each SSB subset consisting of more than one SSBs. The gNB does not need to know the exact SSB selected by the UE, and the information of the selected SSB subset is enough. In this case, the SSBs within the same SSB subset can be mapped to the same PUSCH occasion. One use case of such configuration is that the SSBs within the same SSB subset are transmitted in the same beam direction for SSB repetition,

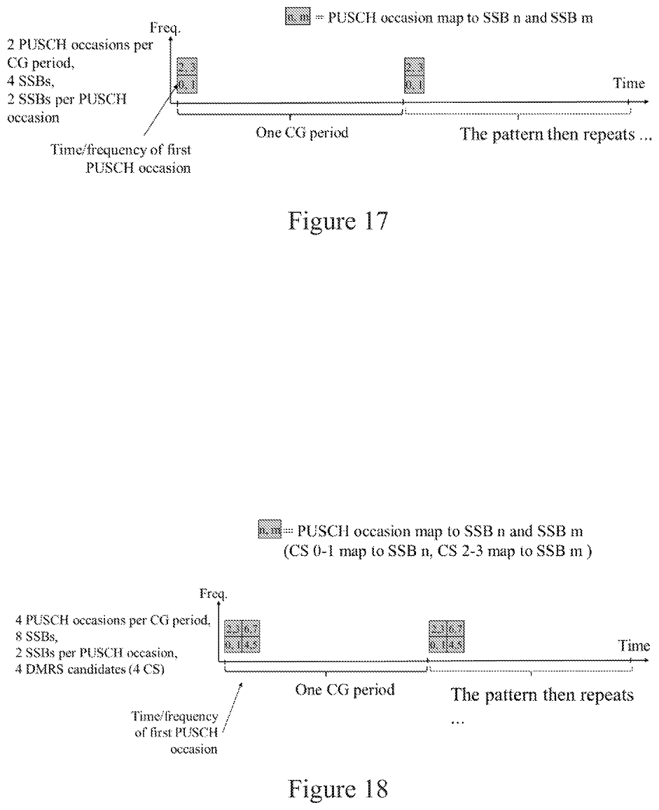

In another embodiment, multiple SSBs are associated to one or more same PUSCH occasions in a CG period. The number of SSBs per PUSCH occasion can be configured via RRC signaling. As an example shown in FIG. 17, 2 SSBs are mapped to the same PUSCH occasion (SSBs 0-1 are mapped to the first PUSCH occasion within a CG period, and SSBs 2-3 are mapped to the second PUSCH occasion within a CG period). With this embodiment, the PUSCH resources overhead can be reduced especially when many SSBs are actually transmitted e.g. in high band.

### 5. Mapping Different SSBs to Different HARQ Processes

When multiple processes are supported for CG-based SDT, following embodiments can be applied. In one embodiment, one or more different SSBs are mapped to one or more different HARQ processes. As an example, a set of SSBs are divided into different SSB subsets with one or more SSBs in each SSB subset, and different SSB subsets are mapped to corresponding PUSCH resources for each HARQ process. In another embodiment, the SSB to CG resource mapping is done per HARQ process. As an example, all SSBs transmitted are mapped to the resources used by each HARQ process independently.

### 6. Mapping Different SSBs to Different CG Configurations

This scheme can be applied when multiple CG configurations are configured for one UE for SDT. Different SSBs are mapped to different CG configurations. In some embodiments, one or more different SSB indexes are mapped to PUSCH resources configured by different CG configurations. As an example, SSBs can be split into different SSB groups with one or more SSBs in each SSB group, and different SSB groups are mapped to corresponding PUSCH resources for each CG configuration.

In another embodiment, the SSB to the CG resource mapping is done per CG configuration. As an example, all SSBs transmitted are mapped to the PUSCH resources configured by each CG configuration independently.

In other embodiments, the set of PUSCH resources may be configured by one CG configuration.

The various schemes proposed above are not mutual exclusive, and can be combined in any applicable manner. In an embodiment, the number of SSBs per PUSCH occasion, the number of PUSCH occasions per CG are explicitly configured, e.g. by a gNB. The association between SSBs and PUSCH resources are derived based on the defined mapping rules.

FIG. 18 shows an example of combing scheme 1 and scheme 4, i.e., associating SSBs to a combination of DMRS configurations and PUSCH occasions per CG period. In this example, 2 SSBs are mapped to one PUSCH occasion, and these two SSBs are further differentiated by using different DMRS configurations (cyclic shifts in this example when transform precoding is enabled).

In an embodiment, the mapping between one or more SSB and PUSCH resources configured for CG based transmission is done by consecutively associating M PUSCH DMRS configurations to each SSB, and as illustrated in FIG. 18. The PUSCH DMRS configurations are taken in the following order:
First, in increasing order of DMRS configuration indexes (e.g., cyclic shifts indexes, DMRS sequences, and/or CDM indexes) within a PUSCH occasion,
Second, in increasing order of frequency resource indexes for frequency multiplexed PUSCH occasions, and
Third, in increasing order in the time domain.

In some embodiments, some PUSCH resources configured for CG-based transmission can be invalidated. The PUSCH resources including PUSCH occasions and/or the DMRS resources can be invalidated for one or more of the following reasons:
The resources are not mapped to any SSBs.
The resources collide with downlink symbols or slot, for example configured by TDD UL/DL configuration or/and the slot format indication

The invalidated PUSCH resources are not used for mapping. The invalidated PUSCH resources are discarded and not used for the CG-based SDT. The invalidation of the PUSCH resources can be either before or after a mapping between an SSB and a PUSCH resource. The PUSCH resources that are not mapped to SSBs can be used for other purposes.

When multiple UEs in proximity need to transmit small data simultaneously to the network, these UEs are likely to select the same SSB beam to associate for their data transmission and reception. In this case, a gNB can configure the PUSCH resources for CG based SDT of different UEs in a smart way, such that it can perform simultaneous transmission or reception for these UEs.

The mapping between an SSB and PUSCH resource can be considered from a perspective of network implementation. It can consider multiple UE scheduling for SDT so that a same receiving beam can be used for multiple resources at the same time occasion for different UEs. In an embodiment, for multiple UEs, their CG PUSCH resources are configured to have the same pattern in the time domain and multiplexed in frequency domain for PUSCH occasions at the same time instance. These CG PUSCH resources can be mapped same SSBs.

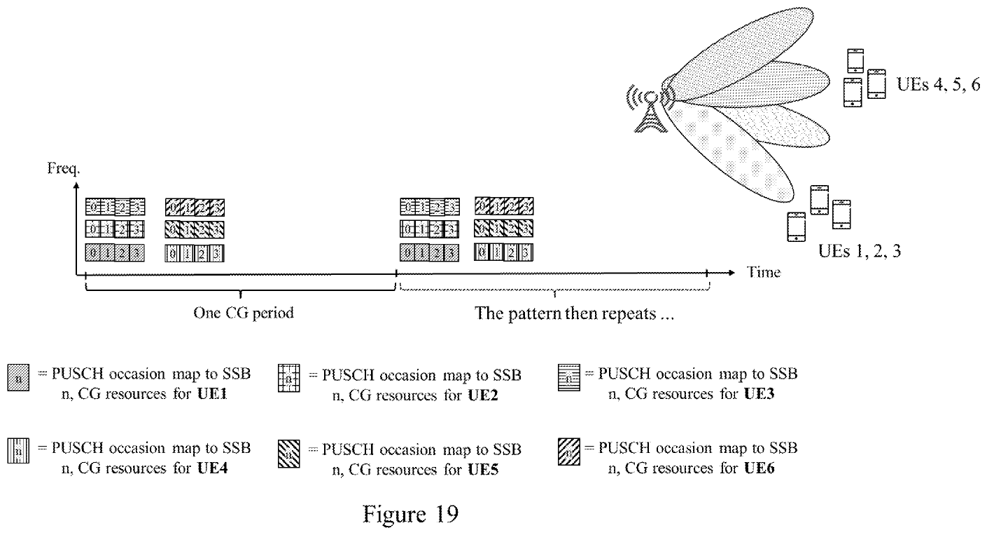

FIG. 19 illustrates an example of the SSBs to CG resources mapping patterns for multiple SDT UEs. As shown in FIG. 19, positions of UE1, UE2, and UE3 are in proximity, and positions of UE4, UE 5, and UE6 are in proximity. The three FDMed PUSCH occasions in a same time instance are mapped to a same SSB. As such, UE1, UE2, and UE3 may select a same SSB, and indicate the selected SSB to a gNB through PUSCH occasions in a same time instance. This type of configuration allows a gNB to perform simultaneous reception of SDT from the multiple UEs using the same reception beam, if the selected SSB are the same for these UEs. Furthermore, the gNB can perform simultaneous transmission of SDT to the multiple UEs using the same beam.

In another embodiment, for multiple UEs, their CG PUSCH resources are configured to have the same time frequency resources but different DMRS resources, so that they can be received on the same PUSCH occasion with a same receiving beam.

It is noted that some embodiments of the present disclosure are mainly described in relation to 5G specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does not limit the present disclosure naturally in any way. Rather, any other system configuration or radio technologies may equally be utilized as long as exemplary embodiments described herein are applicable.

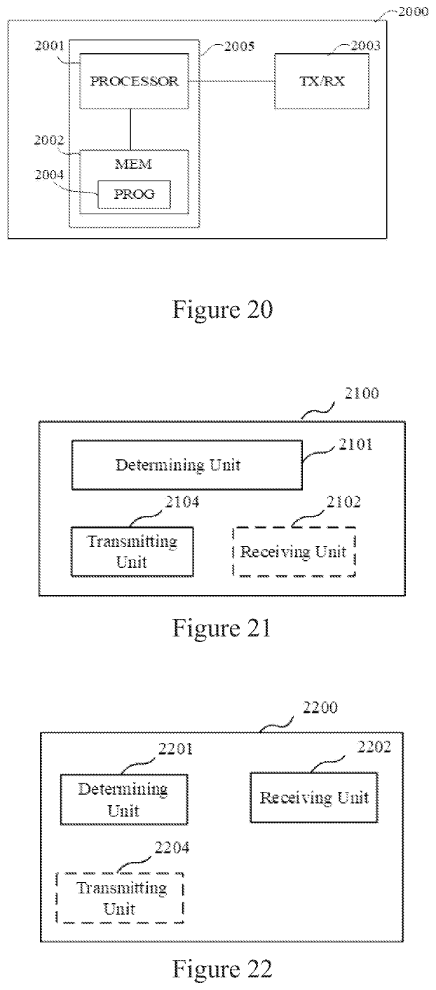

FIG. 20 illustrates a simplified block diagram of an apparatus 2000 that may be embodied in/as a terminal device (e.g., a UE), or a network node (e.g., a gNB). The apparatus 2000 may comprise at least one processor 2001, such as a data processor (DP) and at least one memory (MEM) 2002 coupled to the processor 2001. The apparatus 2000 may further comprise a transmitter TX and receiver RX 2003 coupled to the processor 2001. The MEM 2002 stores a program (PROG) 2004. The PROG 2004 may include instructions that, when executed on the associated processor 2001, enable the apparatus 2000 to operate in accordance with the embodiments of the present disclosure, for example to perform one of the methods 800, 900. A combination of the at least one processor 2001 and the at least one MEM 2002 may form processing means 2005 adapted to implement various embodiments of the present disclosure.

Various embodiments of the present disclosure may be implemented by computer program executable by one or more of the processors 2001, software, firmware, hardware or in a combination thereof.

The MEMs 2002 may be of any type suitable to the local technical environment and may be implemented using any suitable data storage technology, such as semiconductor based memory devices, magnetic memory devices and systems, optical memory devices and systems, fixed memory and removable memory, as non-limiting examples.

The processors 2001 may be of any type suitable to the local technical environment, and may include one or more of general purpose computers, special purpose computers, microprocessors, digital signal processors DSPs and processors based on multicore processor architecture, as non-limiting examples.

Reference is now made to FIG. 21, which illustrates a schematic block diagram of apparatus 2100 in a terminal device, such as a UE. The apparatus 2100 is operable to carry out the exemplary methods 8000 described with reference to FIG. 8, and possibly any other processes or methods.

As shown in FIG. 21, the apparatus 2100 may comprise: a determining unit 2101, which is configured to determine one or more synchronization signal and physical broadcast channel blocks (SSBs); and to determine one or more physical uplink shared channel (PUSCH) resources mapped to the determined one or more SSBs, according to mapping information on mappings between a set of SSBs and a set of PUSCH resources. The apparatus 2100 further comprises a transmitting unit 2104, which is configured to transmit to a network node, data of the CG based transmission by utilizing the determined one or more PUSCH resources.

In some embodiments, the apparatus 2100 may further comprise a receiving unit 2102, which is configured to receive from a network node, a message indicating the mapping information, wherein the message indicates a PUSCH resource associated with an SSB.

Reference is now made to FIG. 22, which illustrates a schematic block diagram of apparatus 2200 in a network node in a wireless communication network, such as a gNB. The apparatus 2200 is operable to carry out the exemplary method 9000 described with reference to FIG. 9, respectively, and possibly any other processes or methods.

As illustrated in FIG. 22, the apparatus 2200 comprises a receiving unit 2202, which is configured to receive from a user equipment, data of the CG based transmission. The apparatus 2200 further comprises a determining unit 2201, which is configured to determine one or more PUSCH resources utilized by the CG based transmission; and to determine one or more synchronization signal and physical broadcast channel blocks (SSBs) mapped to the determined one or more PUSCH resources, according to mapping information on mappings between a set of SSBs and a set of PUSCH resources.

In some embodiments, the apparatus 2200 may further comprise a transmitting unit 2204, which is configured to transmit to the user equipment, a message indicating the mapping information, wherein the message indicates a PUSCH resource associated with an SSB. The transmitting unit 2204 may be further configured to transmit to the user equipment, information by utilizing the determined one or more SSBs.

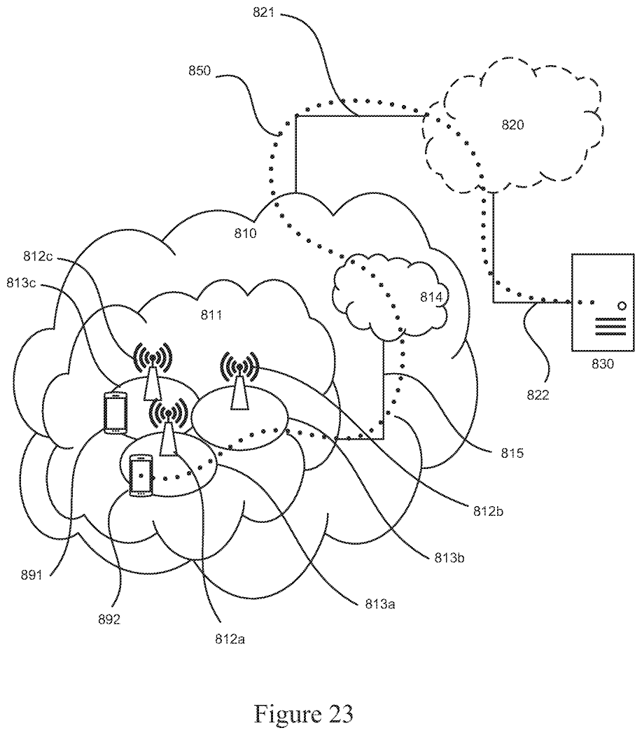

FIG. 23 is a block diagram illustrating a telecommunication network connected via an intermediate network to a host computer in accordance with some embodiments of the present disclosure.

With reference to FIG. 23, in accordance with an embodiment, a communication system includes a telecommunication network 810, such as a 3GPP-type cellular network, which comprises an access network 811, such as a radio access network, and a core network 814. The access network 811 comprises a plurality of base stations 812a, 812b, 812c, such as NBs, eNBs, gNBs or other types of wireless access points, each defining a corresponding coverage area 813a, 813b, 813c. Each base station 812a, 812b, 812c is connectable to the core network 814 over a wired or wireless connection 815. A first UE 891 located in a coverage area 813c is configured to wirelessly connect to, or be paged by, the corresponding base station 812c. A second UE 892 in a coverage area 813a is wirelessly connectable to the corresponding base station 812a. While a plurality of UEs 891, 892 are illustrated in this example, the disclosed embodiments are equally applicable to a situation where a sole UE is in the coverage area or where a sole UE is connecting to the corresponding base station 812.

The telecommunication network 810 is itself connected to a host computer 830, which may be embodied in the hardware and/or software of a standalone server, a cloud-implemented server, a distributed server or as processing resources in a server farm. The host computer 830 may be under the ownership or control of a service provider, or may be operated by the service provider or on behalf of the service provider. Connections 821 and 822 between the telecommunication network 810 and the host computer 830 may extend directly from the core network 814 to the host computer 830 or may go via an optional intermediate network 820. An intermediate network 820 may be one of, or a combination of more than one of, a public, private or hosted network; the intermediate network 820, if any, may be a backbone network or the Internet; in particular, the intermediate network 820 may comprise two or more sub-networks (not shown).

The communication system of FIG. 23 as a whole enables connectivity between the connected UEs 891, 892 and the host computer 830. The connectivity may be described as an over-the-top (OTT) connection 850. The host computer 830 and the connected UEs 891, 892 are configured to communicate data and/or signaling via the OTT connection 850, using the access network 811, the core network 814, any intermediate network 820 and possible further infrastructure (not shown) as intermediaries. The OTT connection 850 may be transparent in the sense that the participating communication devices through which the OTT connection 850 passes are unaware of routing of uplink and downlink communications. For example, the base station 812 may not or need not be informed about the past routing of an incoming downlink communication with data originating from the host computer 830 to be forwarded (e.g., handed over) to a connected UE 891. Similarly, the base station 812 need not be aware of the future routing of an outgoing uplink communication originating from the UE 891 towards the host computer 830.

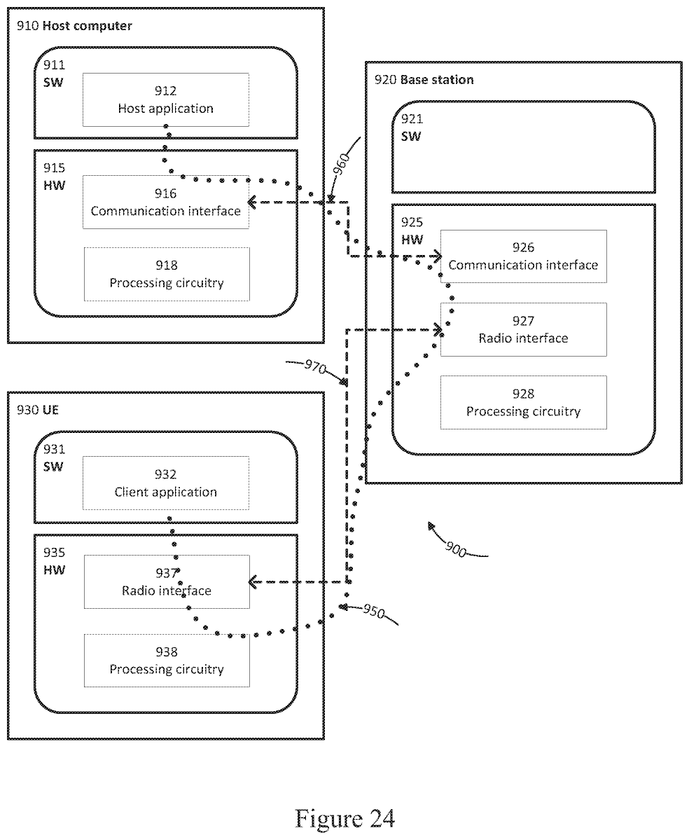

FIG. 24 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 24. In a communication system 900, a host computer 910 comprises hardware 915 including a communication interface 916 configured to set up and maintain a wired or wireless connection with an interface of a different communication device of the communication system 900. The host computer 910 further comprises a processing circuitry 918, which may have storage and/or processing capabilities. In particular, the processing circuitry 918 may comprise one or more programmable processors, application-specific integrated circuits, field programmable gate arrays or combinations of these (not shown) adapted to execute instructions. The host computer 910 further comprises software 911, which is stored in or accessible by the host computer 910 and executable by the processing circuitry 918. The software 911 includes a host application 912. The host application 912 may be operable to provide a service to a remote user, such as UE 930 connecting via an OTT connection 950 terminating at the UE 930 and the host computer 910. In providing the service to the remote user, the host application 912 may provide user data which is transmitted using the OTT connection 950.

The communication system 900 further includes a base station 920 provided in a telecommunication system and comprising hardware 925 enabling it to communicate with the host computer 910 and with the UE 930. The hardware 925 may include a communication interface 926 for setting up and maintaining a wired or wireless connection with an interface of a different communication device of the communication system 900, as well as a radio interface 927 for setting up and maintaining at least a wireless connection 970 with the UE 930 located in a coverage area (not shown in FIG. 24) served by the base station 920. The communication interface 926 may be configured to facilitate a connection 960 to the host computer 910. The connection 960 may be direct or it may pass through a core network (not shown in FIG. 24) of the telecommunication system and/or through one or more intermediate networks outside the telecommunication system. In the embodiment shown, the hardware 925 of the base station 920 further includes a processing circuitry 928, which may comprise one or more programmable processors, application-specific integrated circuits, field programmable gate arrays or combinations of these (not shown) adapted to execute instructions. The base station 920 further has software 921 stored internally or accessible via an external connection.

The communication system 900 further includes the UE 930 already referred to. Its hardware 935 may include a radio interface 937 configured to set up and maintain a wireless connection 970 with a base station serving a coverage area in which the UE 930 is currently located. The hardware 935 of the UE 930 further includes a processing circuitry 938, which may comprise one or more programmable processors, application-specific integrated circuits, field programmable gate arrays or combinations of these (not shown) adapted to execute instructions. The UE 930 further comprises software 931, which is stored in or accessible by the UE 930 and executable by the processing circuitry 938. The software 931 includes a client application 932. The client application 932 may be operable to provide a service to a human or non-human user via the UE 930, with the support of the host computer 910. In the host computer 910, an executing host application 912 may communicate with the executing client application 932 via the OTT connection 950 terminating at the UE 930 and the host computer 910. In providing the service to the user, the client application 932 may receive request data from the host application 912 and provide user data in response to the request data. The OTT connection 950 may transfer both the request data and the user data. The client application 932 may interact with the user to generate the user data that it provides.

It is noted that the host computer 910, the base station 920 and the UE 930 illustrated in FIG. 24 may be similar or identical to the host computer 830, one of base stations 812a, 812b, 812c and one of UEs 891, 892 of FIG. 23, respectively. This is to say, the inner workings of these entities may be as shown in FIG. 24 and independently, the surrounding network topology may be that of FIG. 23.

In FIG. 24, the OTT connection 950 has been drawn abstractly to illustrate the communication between the host computer 910 and the UE 930 via the base station 920, without explicit reference to any intermediary devices and the precise routing of messages via these devices. Network infrastructure may determine the routing, which it may be configured to hide from the UE 930 or from the service provider operating the host computer 910, or both. While the OTT connection 950 is active, the network infrastructure may further take decisions by which it dynamically changes the routing (e.g., on the basis of load balancing consideration or reconfiguration of the network).

Wireless connection 970 between the UE 930 and the base station 920 is in accordance with the teachings of the embodiments described throughout this disclosure. One or more of the various embodiments improve the performance of OTT services provided to the UE 930 using the OTT connection 950, in which the wireless connection 970 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 950 between the host computer 910 and the UE 930, in response to variations in the measurement results. The measurement procedure and/or the network functionality for reconfiguring the OTT connection 950 may be implemented in software 911 and hardware 915 of the host computer 910 or in software 931 and hardware 935 of the UE 930, or both. In embodiments, sensors (not shown) may be deployed in or in association with communication devices through which the OTT connection 950 passes; the sensors may participate in the measurement procedure by supplying values of the monitored quantities exemplified above, or supplying values of other physical quantities from which the software 911, 931 may compute or estimate the monitored quantities. The reconfiguring of the OTT connection 950 may include message format, retransmission settings, preferred routing etc.; the reconfiguring need not affect the base station 920, and it may be unknown or imperceptible to the base station 920. Such procedures and functionalities may be known and practiced in the art. In certain embodiments, measurements may involve proprietary UE signaling facilitating the host computer 910's measurements of throughput, propagation times, latency and the like. The measurements may be implemented in that the software 911 and 931 causes messages to be transmitted, in particular empty or ‘dummy’ messages, using the OTT connection 950 while it monitors propagation times, errors etc.

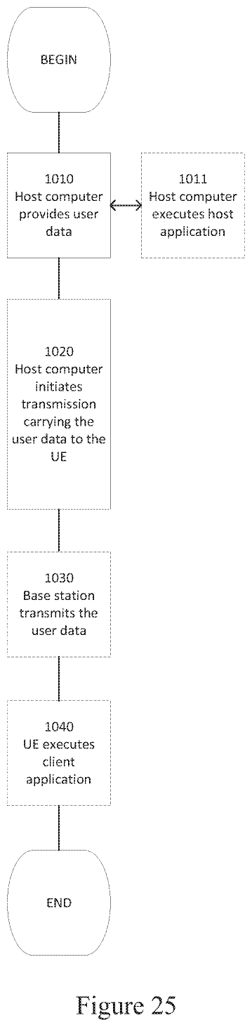

FIG. 25 is a flowchart illustrating a method implemented in a communication system, in accordance with an embodiment. The communication system includes a host computer, a base station and a UE which may be those described with reference to FIG. 23 and FIG. 24. For simplicity of the present disclosure, only drawing references to FIG. 25 will be included in this section. In step 1010, the host computer provides user data. In substep 1011 (which may be optional) of step 1010, the host computer provides the user data by executing a host application. In step 1020, the host computer initiates a transmission carrying the user data to the UE. In step 1030 (which may be optional), the base station transmits to the UE the user data which was carried in the transmission that the host computer initiated, in accordance with the teachings of the embodiments described throughout this disclosure. In step 1040 (which may also be optional), the UE executes a client application associated with the host application executed by the host computer.

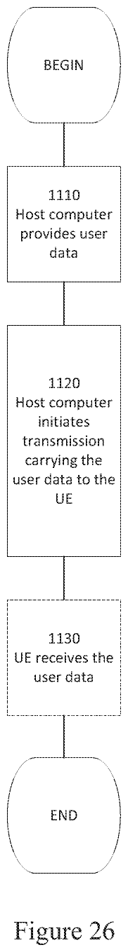

FIG. 26 is a flowchart illustrating a method implemented in a communication system, in accordance with an embodiment. The communication system includes a host computer, a base station and a UE which may be those described with reference to FIG. 23 and FIG. 24. For simplicity of the present disclosure, only drawing references to FIG. 26 will be included in this section. In step 1110 of the method, the host computer provides user data. In an optional substep (not shown) the host computer provides the user data by executing a host application. In step 1120, the host computer initiates a transmission carrying the user data to the UE. The transmission may pass via the base station, in accordance with the teachings of the embodiments described throughout this disclosure. In step 1130 (which may be optional), the UE receives the user data carried in the transmission.

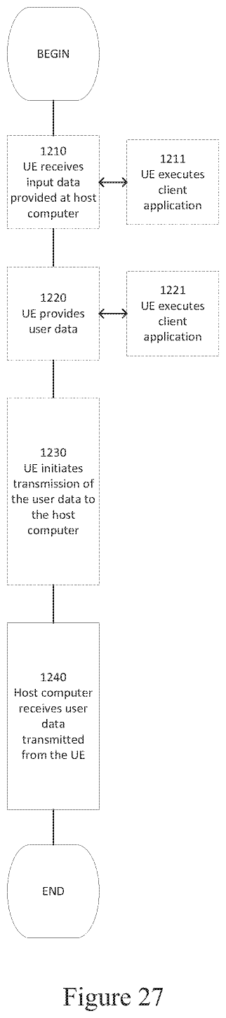

FIG. 27 is a flowchart illustrating a method implemented in a communication system, in accordance with an embodiment. The communication system includes a host computer, a base station and a UE which may be those described with reference to FIG. 23 and FIG. 24. For simplicity of the present disclosure, only drawing references to FIG. 27 will be included in this section. In step 1210 (which may be optional), the UE receives input data provided by the host computer. Additionally or alternatively, in step 1220, the UE provides user data. In substep 1221 (which may be optional) of step 1220, the UE provides the user data by executing a client application. In substep 1211 (which may be optional) of step 1210, the UE executes a client application which provides the user data in reaction to the received input data provided by the host computer. In providing the user data, the executed client application may further consider user input received from the user. Regardless of the specific manner in which the user data was provided, the UE initiates, in substep 1230 (which may be optional), transmission of the user data to the host computer. In step 1240 of the method, the host computer receives the user data transmitted from the UE, in accordance with the teachings of the embodiments described throughout this disclosure.

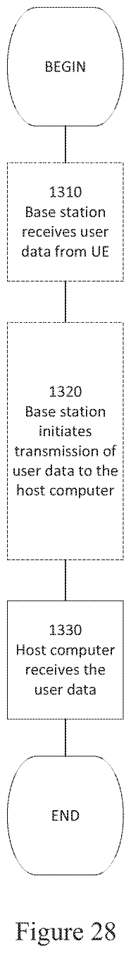

FIG. 28 is a flowchart illustrating a method implemented in a communication system, in accordance with an embodiment. The communication system includes a host computer, a base station and a UE which may be those described with reference to FIG. 23 and FIG. 24. For simplicity of the present disclosure, only drawing references to FIG. 28 will be included in this section. In step 1310 (which may be optional), in accordance with the teachings of the embodiments described throughout this disclosure, the base station receives user data from the UE. In step 1320 (which may be optional), the base station initiates transmission of the received user data to the host computer. In step 1330 (which may be optional), the host computer receives the user data carried in the transmission initiated by the base station.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1-78. (canceled)

79. A method for configured grant (CG) based transmission at a user equipment, the method comprising:
determining one or more synchronization signal and physical broadcast channel blocks (SSBs);
determining one or more physical uplink shared channel (PUSCH) resources mapped to the determined one or more SSBs according to mapping information on mappings between a set of SSBs and a set of PUSCH resources; and
transmitting to a network node data of the CG based transmission by utilizing the determined one or more PUSCH resources.

80. The method of claim 79, further comprising:
receiving from a network node a message indicating the mapping information, wherein the message indicates a PUSCH resource associated with an SSB.

81. The method of claim 79, further comprising:
obtaining configuration of a number of SSBs to be mapped to a PUSCH resource;
obtaining configuration of a number of PUSCH resources available for the CG based transmission; and
deriving one or more PUSCH resources associated with each SSB according to a predefined mapping rule.

82. The method of claim 79, wherein, in the mappings, an SSB in the set of SSBs is mapped to a PUSCH resource in the set of PUSCH resources according to at least one of the following:
demodulation reference signal (DMRS) configuration of PUSCH transmission,
sounding reference signal (SRS) configuration,
one or more PUSCH occasion in one CG period,
PUSCH occasions in multiple CG periods,
hybrid automatic repeat request (HARQ) process, or
one or multiple CG configuration.

83. The method of claim 82, wherein
the set of PUSCH resources comprise DMRS resources configured for the CG based transmission,
different SSBs in the set of SSBs are mapped to different DMRS resources, and
the DMRS resources comprise one or more DMRS ports, and/or one or more DMRS sequences.

84. The method of claim 82, wherein, when transform precoding is disabled, different SSBs in the set of SSBs are mapped to different PUSCH resources in the sets of PUSCH resources according to DMRS configuration of transmission of the physical uplink channel, and the DMRS configuration comprises at least one of the following parameters:
a DMRS sequence scrambling identifier (ID),
a number of the DMRS sequence scrambling ID, or
a DMRS port ID.

85. The method of claim 83, wherein an SSB in the set of SSBs is mapped to multiple DMRS ports.

86. The method of claim 82, wherein an SSB in the set of SSBs is mapped to a PUSCH resource in the set of PUSCH resources according to at least one of the following:
an SRS resource index,
precoding information, or
information on a number of layers.

87. The method of claim 82, wherein
the set of PUSCH resources comprises multiple PUSCH occasions in a CG period, and
one or more different SSBs in the set of SSBs is mapped to one or more different PUSCH occasions in the CG period.

88. The method of claim 87, wherein multiple SSBs in the set of SSBs are mapped to the one or more different PUSCH occasions by associating the one or more different PUSCH occasions to the multiple SSBs in the set of SSBs in an order of consecutive PUSCH occasion indexes.

89. The method of claim 87, wherein different groups of PUSCH occasions are taken from the multiple PUSCH occasions in at least one of the following orders:
an order of frequency resource indexes of the different groups of PUSCH occasions, and
an order of the different groups of PUSCH occasions in time domain.

90. The method of claim 87, wherein more than one SSBs in the set of SSBs are mapped to one or more same PUSCH occasions in the CG period.

91. The method of claim 82, wherein multiple SSBs in the sets of SSBs are mapped to multiple DMRS resources by associating the multiple DMRS resources to the multiple SSB in the set of SSBs in an order of consecutive DMRS resource indexes.

92. The method according to any of claims 91, wherein the order of consecutive DMRS resource indexes is determined according to DMRS resource indexes within a PUSCH occasion, frequency resource indexes of PUSCH occasions, and indexes of PUSCH occasions in time domain.

93. The method of claim 82, wherein
the set of PUSCH resources comprise PUSCH resources in multiple HARQ processes, and an SSB in the set of SSBs is mapped to one or more HARQ processes of the multiple HARQ processes, or
the set of PUSCH resources comprise multiple PUSCH resources in a HARQ process, and different SSBs in the set of SSBs are mapped to different PUSCH resources in the HARQ process.

94. The method of claim 82, wherein
the set of PUSCH resources comprises PUSCH resources configured by multiple CG configuration, and one or more different SSB indexes are mapped to PUSCH resources configured by different CG configuration,
the set of PUSCH resources comprises PUSCH resources configured by multiple CG configuration, and the set of SSBs are mapped to PUSCH resources configured by each CG configuration, or
the set of PUSCH resources are configured by one CG configuration.

95. The method of claim 79, wherein
the set of PUSCH resources comprises PUSCH occasions and/or DMRS resources, and
the method further comprises invalidating a PUSCH resource that fulfills at least one of the following conditions:
the PUSCH resource is not mapped to any SSBs, or
the PUSCH resource collides with a downlink symbol or slot, wherein the invalidated PUSCH resource is not used for mapping to the set of SSBs.

96. The method of claim 79, wherein multiple SSB indexes are mapped to one or more same PUSCH resources in the set of PUSCH resources.

97. The method of claim 79, wherein the CG based transmission is a CG-based small data transmission.

98. An apparatus for configured grant (CG) based transmission at a user equipment, the method comprising, the apparatus comprising:
one or more processors; and
one or more memories comprising computer program codes,
the one or more memories and the computer program codes configured to, with the one or more processors, cause the apparatus to:
determine one or more synchronization signal and physical broadcast channel blocks (SSBs);
determine one or more physical uplink shared channel (PUSCH) resources mapped to the determined one or more SSBs, according to mapping information on mappings between a set of SSBs and a set of PUSCH resources; and
transmit to a network node, data of the CG based transmission by utilizing the determined one or more PUSCH resources.
